(19) United States
(12) Patent Application Publication
(10) Pub. No.: US 2011/0075425 A1
(43) Pub. Date: Mar. 31, 2011

(54) WIDE-SPAN REFLECTION STRUCTURE

(76) Inventor: Chia-Mao Li, Taipei (TW)

(21) Appl. No.: 12/566,686

(22) Filed: Sep. 25, 2009

(51) Int. Cl. F21V 29/00

(52) U.S. Cl. 362/294

(57) ABSTRACT

A wide-span reflection structure has a reflection cup, a metal heat sink and a heat conductive base. The heat conductive base has an embedded trough to provide the metal heat sink to be embedded firmly. The outer ring of the metal heat sink is embedded firmly with the reflection cup suitable to a plane-shining character of a LED light. At least a reflection light element is installed in the reflection cup. The reflection light element has a curved surface. Considering a LED character of facade shining, the over-strong light in the middle of a LED light can be reflected towards another side by through the curved surface of the reflection light element so as to increase a wide-span of shining area. The wide-span reflection structure is capable of spreading evenly out light so as to reach goals of higher light efficiency and saving energy.

### FIELD OF THE INVENTION

The present invention relates to a wide-span reflection structure, in particular to a reflection structure capable of increasing shining wide-span of reflection light and having evenly illumination of shining surface. In order to deal with an LED character of facade shining, the wide-span reflection structure has a reflection light element installed in the suitable middle section of a reflection cup so that middle stronger light is reflected through a curved surface of the reflection light element to another side.

### BACKGROUND OF THE INVENTION

LED lamps or lanterns are more and more popular among current lighting market. Conventional lampshade is used an inside surface to reflect light to increase light utilization and enhance brightness of a lamp. For instance, in one prior art, the light shape of the prior art of the LED light is elliptic so that the centralized light in the middle section is stronger than the side light, referring to FIG. 1. The prior art does not consider some light requirement. Particularly, a shining area of lamp irradiation is not wide-enough for road illumination. In addition, some application of the prior art is used an arranging way with a specific angle to irradiate light. The way of the prior art may reach a requirement of illumination, but the way caused over-glaringness seriously and harsh user's eyes. The prior art is not only difficult to reach a necessary requirement, but also need a higher cost and have a complex structure. Comparing to the prior art, the present invention is simpler for manufacture.

### SUMMARY OF THE INVENTION

The primary objective of the present invention is to improve the prior art of a wide-span reflection structure of a LED light, by using a curved surface to reflect light so as to increase a shining wide-span of illumination area.

The wide-span reflection structure of the present invention has a reflection cup, a metal heat sink and a heat conductive base. The heat conductive base has an embedded trough. The embedded trough is used for embedding firmly in the metal heat sink. The metal heat sink has a heat conductive surface which suits for a plane-shining character of a LED light so as to refract the light and increase shining efficiency. Besides, the metal heat sink is good for heat conduction and has a large heat capacity so as to absorb fast the heat of a LED chip. By through larger surface area of the metal heat sink, the heat is spread out the heat conductive base so that the heat produced by the LED chip of the metal heat sink is capable of diffusing quickly on air. Then the temperature on the LED chip is reduced considerably. The outer ring of the metal heat sink is embedded firmly with the reflection cup suitable to a plane-shining character of a LED light. At least a reflection light element is installed in the reflection cup. The reflection light element has a curved surface. Considering a LED character of facade shining, the over-strong light in the middle of a LED light can be reflected towards another side by through the curved surface of the reflection light element so as to increase a wide-span of shining area. The present invention is also capable of spreading evenly out light so as to reach goals of higher light efficiency and saving energy.

Comparing to the prior art, the present invention of the wide-span reflection structure is capable of increase shining wide-span of illumination area, by using a curved surface to reflect light.

### BRIEF DESCRIPTION OF THE DRAWINGS

FIG. 1 is illustrated with the prior art lamp.

FIG. 2 is an integrated perspective view of the wide-span reflection structure of the present invention.

FIG. 3 is an exploded perspective view of the wide-span reflection structure of the present invention.

FIG. 4 is a cross-sectional view of the wide-range reflection assembly of the present invention.

FIG. 5 is illustrated with the embodiment of conductive light of the present invention.

FIG. 6 is illustrated with the embodiment of the present invention.

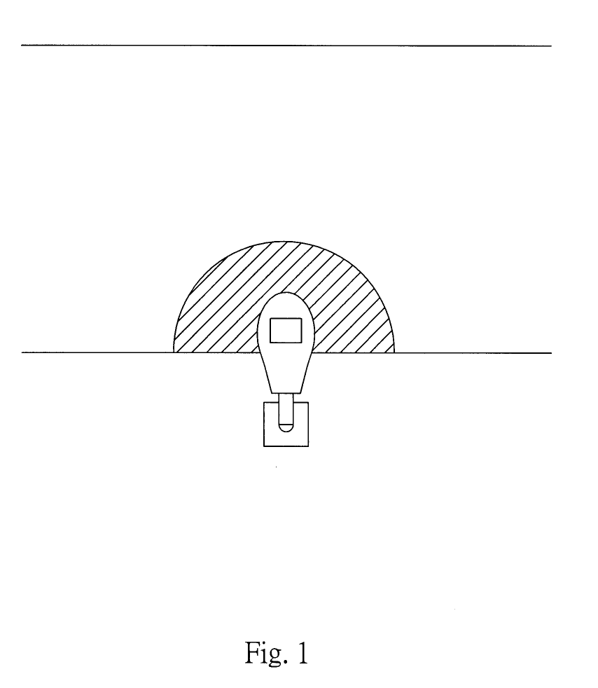

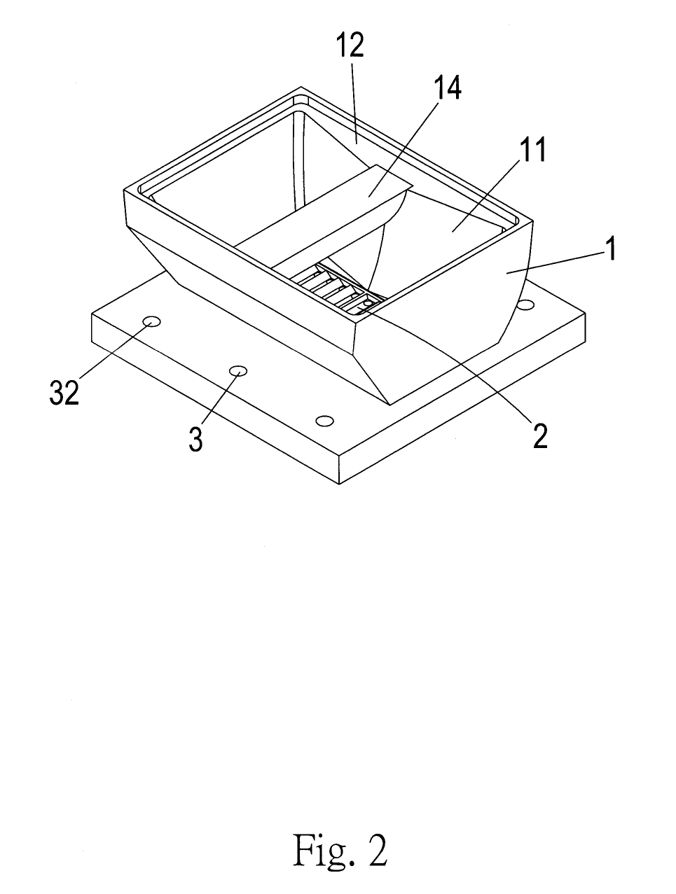

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

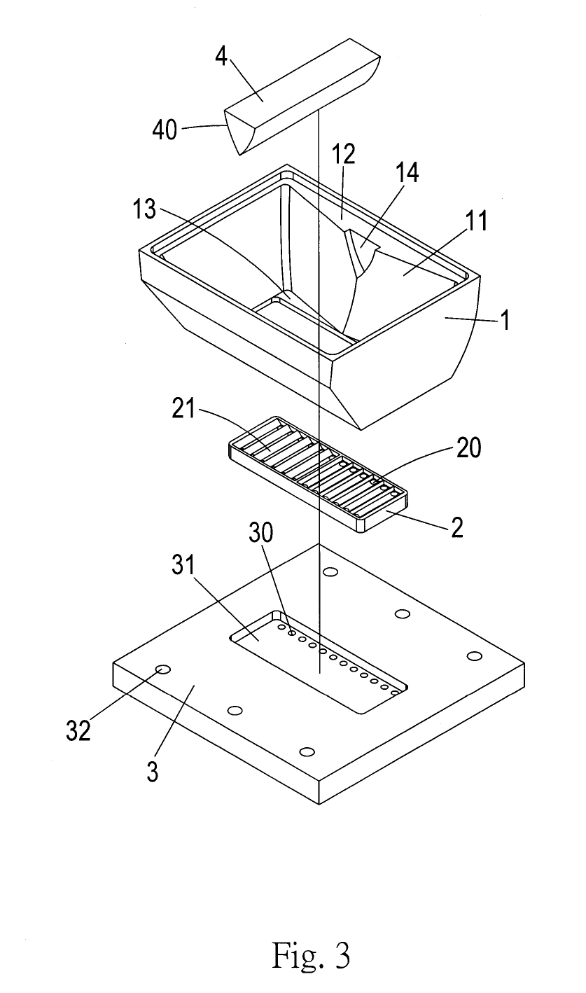

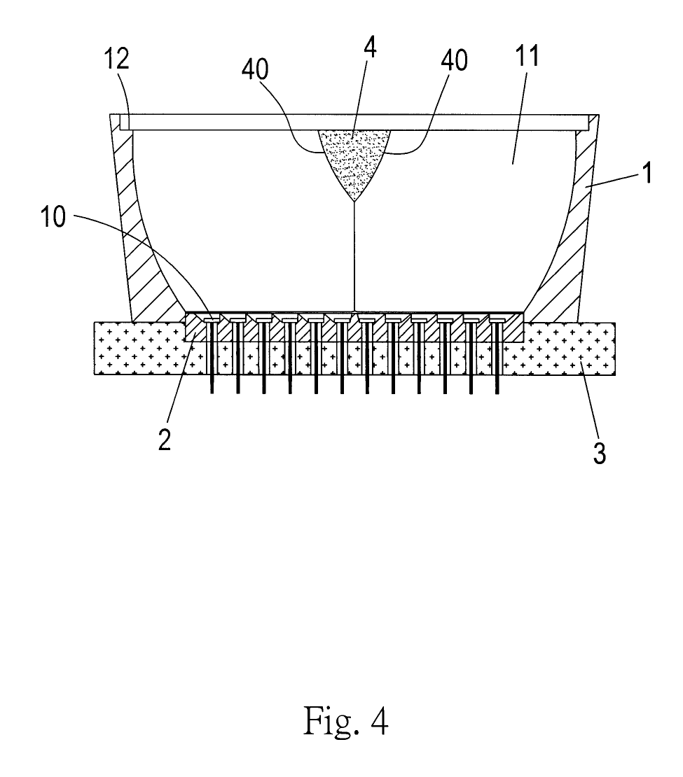

Referring to FIGS. 2 to 4, the present invention provides a wide-span reflection structure, comprising a reflection cup 1, a metal heat sink 2 and a heat conductive base 3. The heat conductive base 3 has an embedded trough 31 and a penetrating hole 32. The embedded trough 31 is used for embedding and fixing the metal heat sink 2. The penetrating hole 32 is used for locking a screw on a lamp. Besides, the embedded trough 32 has a through hole 30. The metal heat sink 2 is installed on a heat conductive surface 21 which suits for a plane-shining character of a LED light so as to refract the light and increase shining efficiency. The metal heat sink 2 has the through hole 20. The through hole 20 is used for installing a LED chip 10.

The metal heat sink 2 is good for heat conduction and has a large heat capacity so as to absorb fast the heat of the LED chip 10. By through larger surface area of the metal heat sink 2, the heat is spread out the heat conductive base 3 so that the heat produced by the LED chip 10 of the metal heat sink 2 is capable of diffusing quickly on air. Then the temperature on the LED chip 10 is reduced considerably. The outer ring of the metal heat sink 2 is embedded firmly with the reflection cup 1 suitable to a plane-shining character of a LED light. The reflection cup 1 is a hollow shape. The reflection cup 1 has a reflection light curved surface 11. One side of the reflection cup 1 has a concave fringe 12. Another side of the reflection cup 1 has a tangent plane 13 combined with the outer ring of the metal heat sink 2. At least a reflection light element 4 is installed in the reflection cup 1. The both sides of the reflection cup 1 have embedded holes 14 so that the reflection light element 4 can be installed. The reflection light element 4 has a special curved surface.

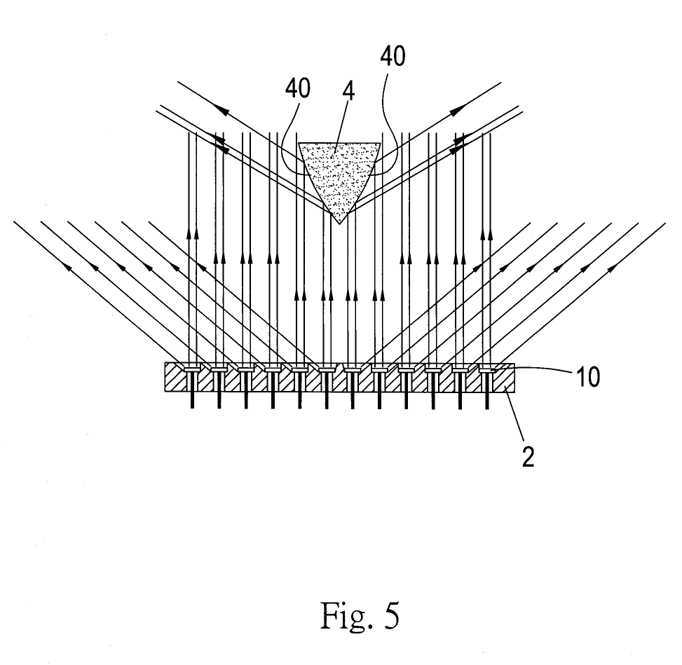

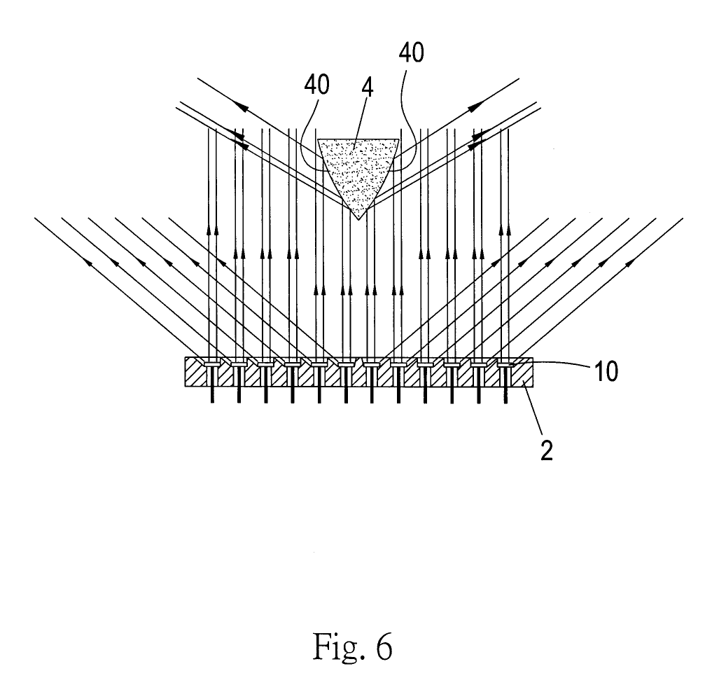

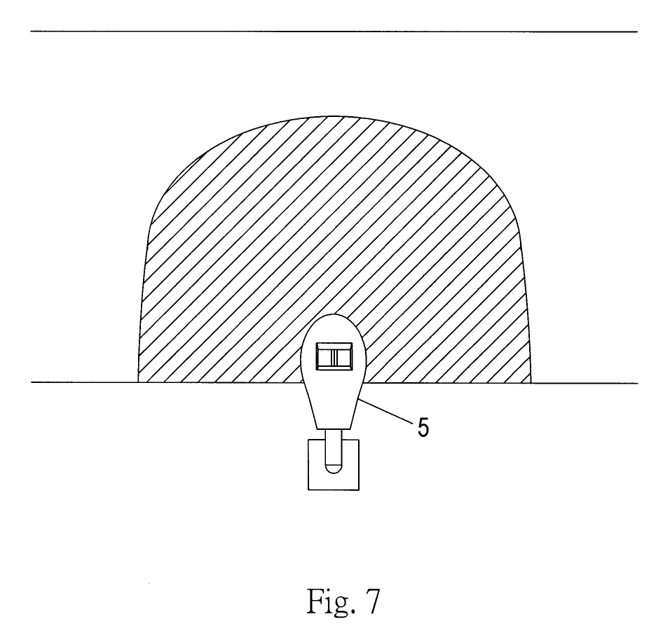

Referring to FIGS. 5 and 6, the present invention is applied to various lighting equipments, such as a streetlamp. The reflection light element 4 is installed in the suitable middle place of the reflection cup 1. Considering a LED character of facade shining, the over-strong light in the middle of a LED light can be reflected towards another side by through a curved surface 40 of the reflection light element 4 so as to increase a wide-span of shining area. The present invention is also capable of spreading evenly out light so as to reach goals of higher light efficiency and saving energy.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claim is:

1. A wide-span reflection assembly comprising:
a reflection cup;
a metal heat sink;
a heat conductive base;
wherein the heat conductive base has an embedded trough; the embedded trough is used to be embedded firmly in the metal heat sink; the outer ring of the metal heat sink is embedded firmly with the reflection cup suitable to a plane-shining character of a LED light; at least a reflection light element is installed in the reflection cup and the reflection light element has a curved surface.

2. The wide-range reflection assembly as claimed in claim 1, wherein the metal heat sink has a heat conductive surface suitable for a plane-shining character of an LED light.

3. The wide-range reflection assembly as claimed in claim 1, wherein the metal heat sink has a penetrating hole for installing an LED chip.

4. The wide-range reflection assembly as claimed in claim 1, wherein a reflection light curved surface is installed in the reflection cup.

5. The wide-range reflection assembly as claimed in claim 1, wherein an embedded trough is installed in the reflection cup; and the embedded trough is used to install the reflection light element.
